(19) United States
(12) Patent Application Publication
(10) Pub. No.: US 2010/0323668 A1
(43) Pub. Date: Dec. 23, 2010

(54) DEVICE STATUS NOTIFICATION METHOD, APPARATUS, AND NOTIFICATION SYSTEM

(75) Inventor: Kazuki MATSUI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/778,441

(22) Filed: May 12, 2010

(30) Foreign Application Priority Data
Jun. 19, 2009 (JP) 2009-146159

(51) Int. Cl. H04W 4/00

(52) U.S. Cl. 455/412.2

(57) ABSTRACT

An apparatus includes a memory which stores notification information for notifying status of the apparatus in association with status information indicating a status of the apparatus. The apparatus also includes a request acquisition unit which acquires a status notification request from an external apparatus, and a detector which detects the status. The apparatus specifies a notification associated with the status detected by the detector on the basis of the notification information and the status information stored in the memory, and issues a notification according to the specified notification when a status notification request is acquired by the request acquisition unit.

### CROSS-REFERENCE TO RELATED APPLICATIONS

This application is based upon and claims the benefit of priority of the prior Japanese Patent Application No. 2009-146159, filed on Jun. 19, 2009, the entire contents of which are incorporated herein by reference.

### FIELD

The embodiments discussed herein are relate to technology that provides benefits including in association with determining a content set and/or provided in a device according to an outward appearance of the device.

### BACKGROUND

Mobile devices such as notebook computers, smart phones, and personal digital assistants (PDAs) are subjected to various work operations in advance according to their intended usage. For example, applications such as an OS and other relevant software may be installed, and various configuration settings may be applied.

Such work operations, also generally referred to as kitting, are fundamentally conducted on a per-device basis. For example, mobile devices are typically connected one at a time to a device for kitting work by a Universal Serial Bus (USB) cable, and then installation and other operations are conducted.

Kitting does not pose a significant problem if, for example, the work for a plurality of devices at the factory shipping stage can be completed at once, before delivery to customers. However, if progress differs among individual devices during the process of performing the work, then at any given time, the types of applications to install and the settings to be configured will differ among each device. Consequently, to correctly identify per-device status, suitable kitting is conducted individually on a per-device basis.

In the case of kitting several dozen to several hundred mobile devices, a check is required to be performed to determine whether or not kitting was conducted correctly, such as whether the installation of a given application succeeded or failed, for example. However, since such a check involves performing checking operations on a per-device basis, significant labor is involved.

Furthermore, when kitting a large number of mobile devices, the applications to install often differ according to the mobile device. Moreover, if the number of mobile devices to be kitted out is large, then kitting work may last for several days. In this case, mobile devices that have been kitted out become mixed with mobile devices that have not yet been kitted out.

In such cases, if the kitting status of the mobile devices (such as the installed applications, for example) could be ascertained from the outward appearance of the mobile devices, then it would become possible to swiftly perform kitting work without manually checking one device at a time.

### SUMMARY

According to an embodiment, an apparatus includes a memory which stores notification information indicating a notification for notifying status of the apparatus in association with status information indicating a status of the apparatus. The apparatus also includes a request acquisition unit which acquires a status notification request from an external apparatus, and a detector which detects the status. The apparatus specifies a notification associated with the status detected by the detector on the basis of the notification information and the status information stored in the memory, and issues a notification according to the specified notification, when a status notification request is acquired by the request acquisition unit.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a status notification system of an embodiment;

FIG. 2 illustrates notifications of a kitting status of a mobile device;

FIG. 3 illustrates a mobile device and a kitting apparatus;

FIG. 4 illustrates a check data management table;

FIG. 5 illustrates a per-application management table;

FIGS. 6A, 6B and 6C illustrate check data;

FIGS. 7A and 7B illustrate install logs;

FIG. 8 illustrates a flowchart of a kitting process and a kitting check process;

FIG. 9 illustrates the status notification system of an embodiment;

FIG. 10 illustrates a managing server, a mobile device, and a kitting apparatus;

FIG. 11 illustrates a per-device management table;

FIG. 12 illustrates a flowchart of a kitting check process; and

FIG. 13 illustrates a flowchart of a difference determining process.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

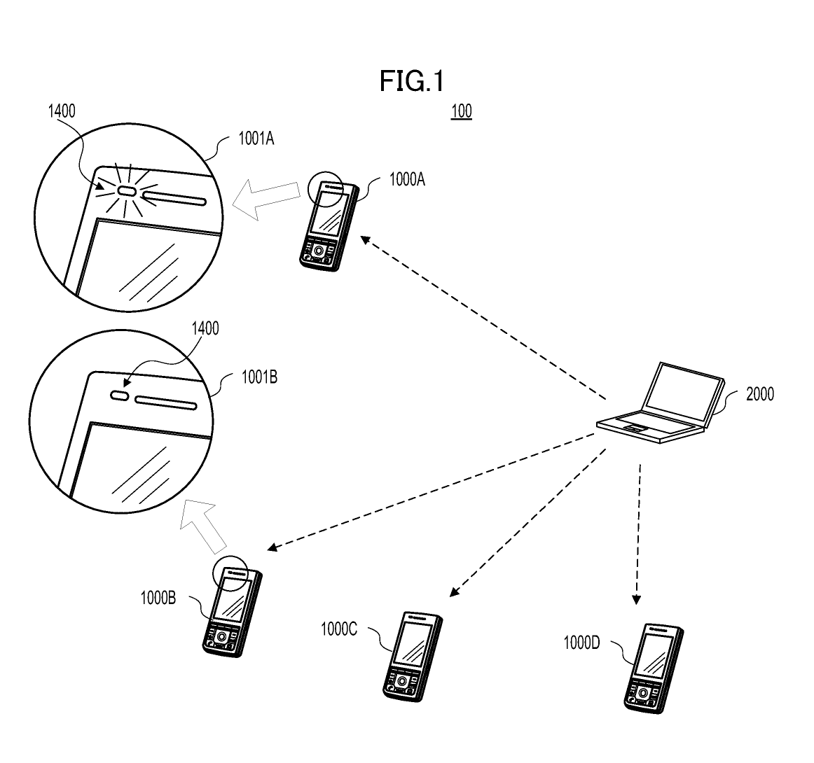

FIG. 1 illustrates an exemplary configuration of the status notification system 100 of an embodiment.

The status notification system 100 includes a mobile device 1000A, a mobile device 1000B, a mobile device 1000C, and a mobile device 1000D to be kitted out, as well as a kitting apparatus 2000.

The mobile devices 1000A, 1000B, 1000C and 1000D (1000A to 1000D unless otherwise specified) and the kitting apparatus 2000 communicate wirelessly via a protocol such as a wireless local area network (LAN) or Bluetooth (registered trademark, same hereinafter).

For the sake of convenience, FIG. 1 illustrates four mobile devices (1000A to 1000D) to be kitted out. In addition, the mobile devices 1000A to 1000D have respectively similar exteriors and functions.

Hereinafter, the mobile devices 1000A to 1000D are collectively referred to as the mobile devices 1000, with the mobile device 1000A being referred to as the mobile device A, the mobile device 1000B as the mobile device B, the mobile device 1000C as the mobile device C, and the mobile device 1000D as the mobile device D.

The mobile devices 1000 are information appliances, such as mobile phone handsets, smartphones, PDAs, or notebook computers. Each mobile device 1000 is provided with a light emitting diode (LED) lamp 1400, which is used as a power indicator or similar function. The enlarged view 1001B illustrates an unlighted LED lamp 1400, while the enlarged view 1001A illustrates a lighted LED lamp 1400.

The mobile devices 1000 of the status notification system 100 issue notifications of kitting status by using this LED lamp 1400.

The kitting apparatus 2000 installs application(s) onto each of the mobile devices 1000, and performs other operation(s) such as configuring relevant settings. In an embodiment, the kitting apparatus 2000 is considered to be a notebook computer.

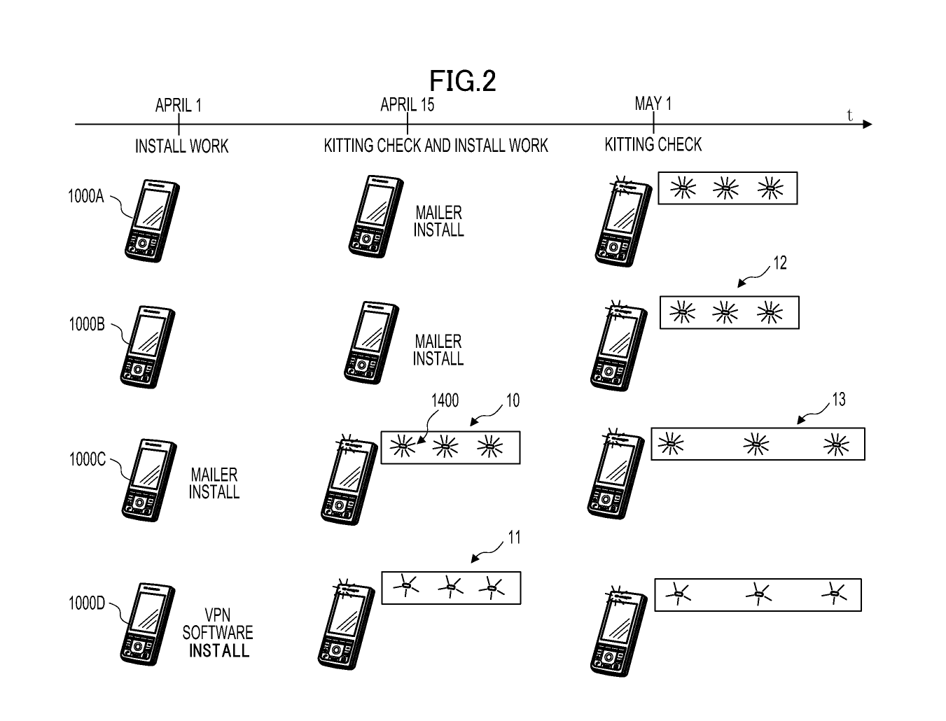

Exemplary notifications of kitting status by the mobile devices 1000 of the status notification system 100 will now be described with reference to FIG. 2.

An example will be described for the case of performing kitting work on the mobile devices A, B, C, D (A to D unless otherwise indicated) over the course of three days.

In FIG. 2, a rectangle 10 indicates that the LED lamp 1400 is blinking blue. Similarly to the rectangle 10, a rectangle 11 also indicates that the LED lamp 1400 is blinking, but the rectangle 11 indicates that the LED lamp 1400 is blinking a different color (green). In addition, a rectangle 13 with the long spacing between the lights of the LED lamp 1400 indicates that the blinking interval is long compared to the blinking indicated by the rectangle 10. While specific examples of indicators are provided herein, the present invention is not limited to any particular type of indicator.

The kitting work performed by the kitting worker herein involves installing a mailer onto three of the four mobile devices 1000, and installing virtual private network (VPN) software onto one of the mobile devices 1000.

First, on April 1, the mailer is installed onto the mobile device C, and the VPN software is installed onto the mobile device D.

Next, on April 15, the mailer is to be installed onto the mobile device A and the mobile device B. At this point, there is no way to determine which mobile device 1000 was installed with the mailer and which was installed with the VPN software on April 1, unless each mobile device 1000 is made to display or otherwise indicate a notification of its installation status.

Thus, the kitting worker operates the kitting apparatus 2000 (FIG. 1), and transmits to each of the mobile devices 1000 a check command, which causes the mobile devices 1000 to issue notifications indicating what kind of kitting has been performed.

Having received the check command, the mobile device C indicates that the mailer has been installed thereon. In other words, the mobile device C causes its LED lamp 1400 to blink blue at a predetermined blinking interval (see rectangle 10).

Meanwhile, having received the check command, the mobile device D indicates that the VPN software has been installed thereon. In other words, the mobile device D causes its LED lamp 1400 to blink green at a predetermined blinking interval (see rectangle 11).

At this point, neither the mailer nor the VPN software has been installed onto the mobile devices A and B, and thus their LED lamps 1400 do not blink.

By viewing the blinking of the LED lamps, the kitting worker ascertains that applications have not yet been installed onto the mobile device A and the mobile device B, and thus the kitting worker installs the mailer onto the mobile device A and the mobile device B.

Next, assume that version changes are necessitated in the mailer and the VPN software that were installed on April 1, and that the change will be conducted on May 1.

In this case, the kitting worker operates the kitting apparatus 2000, and transmits a check command to each of the mobile devices 1000.

The mobile devices A and B indicate that the mailer has been installed thereon. In other words, the mobile devices A and B cause their respective LED lamps 1400 to blink blue at a predetermined blinking interval (see rectangle 12).

The mobile device C also indicates that the mailer has been installed thereon. In other words, the mobile device C causes its LED lamp 1400 to blink blue. However, the blinking interval in this case is longer than the blinking interval of the LED lamp 1400 in the mobile device A (see rectangle 13).

The blinking interval is determined according to the time between when an application is installed onto a mobile device 1000, and when a check command is received. As this time increases, the blinking interval becomes longer.

The mobile device D also indicates that the VPN software has been installed thereon. In other words, the mobile device D causes its LED lamp 1400 to blink green. The blinking interval is the same interval as that of the mobile device C.

The kitting worker installs the new version of the mailer onto the mobile device C whose LED lamp 1400 is blinking blue at a long interval. In addition, the kitting worker installs the new version of the VPN software onto the mobile device D whose LED lamp 1400 is blinking green at a long interval.

In other words, the mobile devices 1000 of the status notification system 100 are able to use their respective LED lamps 1400 to not only indicate which applications have been installed thereon, but also to indicate approximately when the applications were installed.

In this way, each mobile device 1000 notifies the kitting worker of its installed applications and the time of installation by causing its LED lamp 1400 to blink. In other words, the kitting worker is notified by an indicator such as an outward appearance of the mobile devices 1000. In so doing, the kitting worker is able to ascertain the kitting status. Consequently, the kitting work is able to quickly execute the next work operations to be performed with respect to each of the mobile devices 1000, such as performing version upgrades and applying various configuration settings, without having to perform operations to check the kitting status one device at a time.

FIG. 2 illustrates the case of software being successfully installed. However, the LED lamp 1400 may also be made to blink red, for example, in the case of software failing to install. The kitting worker is thus able to immediately ascertain which mobile device 1000 had an installation failure (i.e., which mobile device 1000 has an LED lamp 1400 that is blinking red), and can then install the application that should be installed onto that mobile device 1000. While the mobile device 1000 are described as causing an LED lamp to blink, the present invention is not limited to providing any particular type of indicator of a status.

Hereinafter, the status notification system 100 will be described with reference to the drawings.

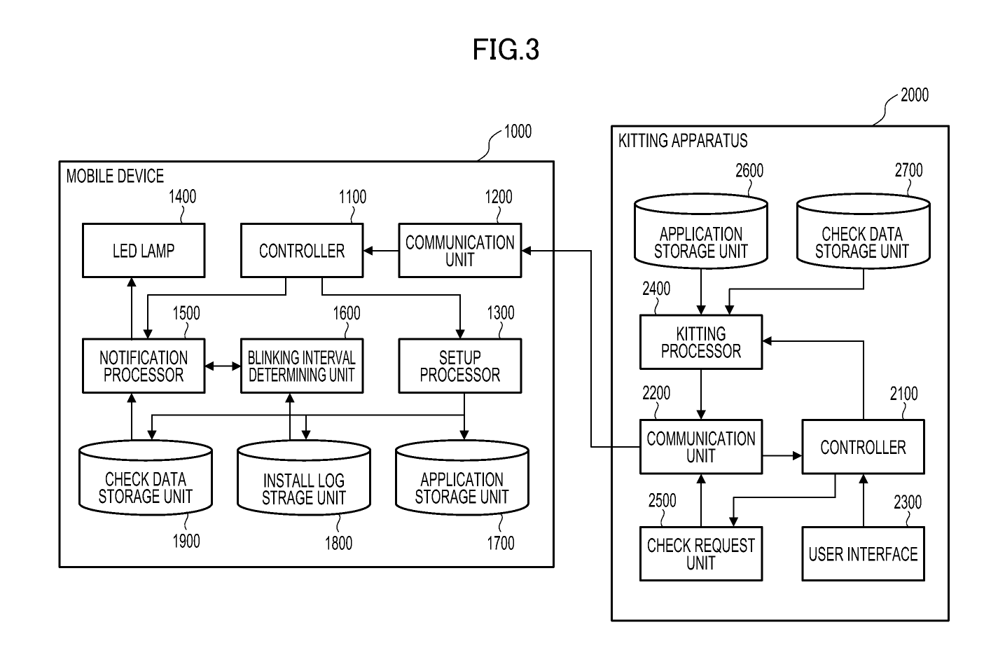

FIG. 3 is a block diagram illustrating an exemplary functional configuration of one of the mobile devices 1000 and the kitting apparatus 2000.

The mobile device 1000 includes a controller 1100, a communication unit 1200, a setup processor 1300, an LED lamp 1400, a notification processor 1500, a blinking interval determining unit 1600, an application storage unit 1700, an install log storage unit 1800, and a check data storage unit 1900.

The controller 1100 realizes the functions that are basically included in the mobile device 1000. For example, if the mobile device 1000 is a mobile phone handset, then the controller 1100 realizes functions such as telephony. In addition, the controller 1100 also controls the other function units described above.

The communication unit 1200 wirelessly communicates including with the kitting apparatus 2000.

The setup processor 1300 kits out its own mobile device 1000 with information such as applications and check data received from the kitting apparatus 2000. More specifically, the setup processor 1300 receives from the kitting apparatus 2000 an installer of an application to be installed, and launches the received installer. The launched installer causes information, such as the application's executable file and data used by the application received from the kitting apparatus 2000, to be stored in the application storage unit 1700, while also configuring relevant settings. In addition, the setup processor 1300 causes check data received from the kitting apparatus 2000 to be stored in the check data storage unit 1900.

The LED lamp 1400 is a lamp that uses a semiconductor element.

The notification processor (i.e., notification means) 1500 executes processing for issuing notification(s) of a kitting status. More specifically, the notification processor 1500 issues notifications on the basis of check data stored in the check data storage unit 1900. For example, in the case where the notification method indicated by the check data is a method that uses an LED, the notification processor 1500 causes the LED lamp 1400 to blink the color indicated by the check data at a blinking interval that corresponds to the elapsed time between when the application was installed and when the notification is issued.

The blinking interval determining unit 1600 includes functions for determines the blinking interval of the LED lamp 1400 on the basis of a request from the notification processor 1500. More specifically, the blinking interval determining unit 1600 refers to the install log to determine the elapsed time between when the acquired application was installed and when a check command was received. On the basis of the elapsed time, the blinking interval determining unit 1600 determines the blinking interval.

For example, the default value for the blinking interval may be 500 ms (milliseconds), increasing by 100 ms for each day that elapses since installation. The blinking interval after 30 days have elapsed thus becomes 500 ms+100 ms*30 days=3500 ms.

The application storage unit 1700 stores information such as the installed application's executable file and data used by the application.

The install log storage unit 1800 includes functions for storing a log of the install processes for applications installed onto the mobile device 1000. One install log is added each time an application is installed.

The check data storage unit 1900 stores check data associated with installed applications. The check data differs by application type. In addition, only the check data associated with the most recently installed applications is stored in the check data storage unit 1900.

Meanwhile, the kitting apparatus 2000 includes a controller 2100, a communication unit 2200, a user interface 2300, a kitting processor 2400, a check request unit 2500, an application storage unit 2600, and a check data storage unit 2700.

The controller 2100 realizes functions including thoseof a typical personal computer relevant to the kitting apparatus 2000 herein described as a notebook computer. In addition, the controller 2100 controls the other function units described above.

The communication unit 2200 wirelessly communicates with the mobile devices 1000. In an embodiment, the communication unit 2200 connects to and communicates with the mobile devices 1000 by wireless LAN when installing an application onto a mobile device 1000, when configuring various settings, and when transmitting a check command.

The user interface 2300 includes a keypad or similar elements, and detects user operations such as the pressing of keys.

The kitting processor 2400 includes functions for installing an application onto a mobile device 1000, for example. In an embodiment, the kitting processor 2400 transmits the following information to a mobile device 1000 via the communication unit 2200: the installer of an application to be installed, the application's executable file, data used by the application, and check data associated with the application.

The check request unit 2500 generates a check command, and transmits the command to the mobile devices 1000 via the communication unit 2200.

The application storage unit 2600 stores information such as the executable files for various types of applications, respective data used by each application, and the installers for each application.

The check data storage unit 2700 stores per-application check data associated with each application stored in the application storage unit 2600.

The various functions described above are realized as a result of the respective CPUs included in the mobile devices 1000 and the kitting apparatus 2000 executing program(s) stored in the respective memories or similar components of the mobile devices 1000 and the kitting apparatus 2000.

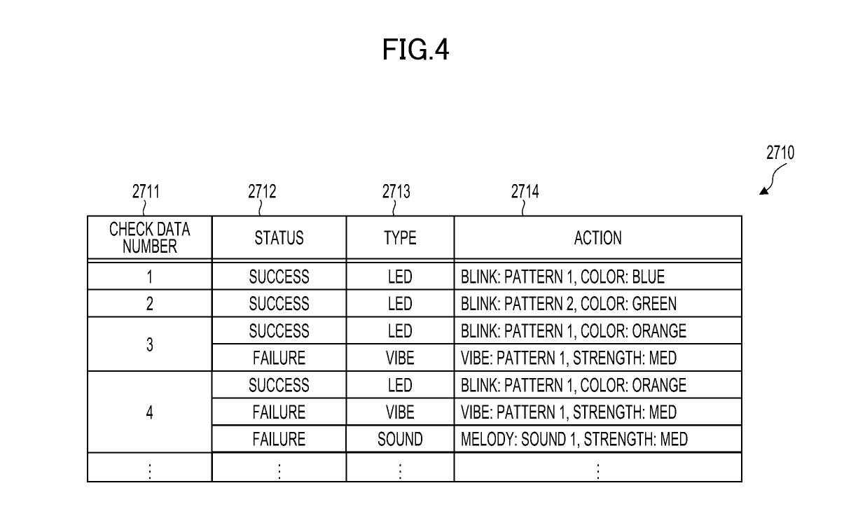

Data used by the status notification system 100 will now be described using FIGS. 4 to 7B.

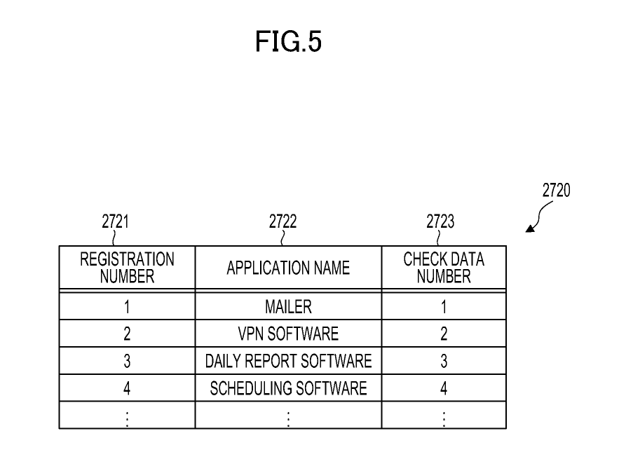

FIG. 4 illustrates an example of a structure and content of a check data management table 2710. FIG. 5 illustrates an example of a structure and content of a per-application management table 2720.

The check data management table 2710 and the per-application management table 2720 are stored in the per-application check data storage unit 2700 of the kitting apparatus 2000 in advance by the kitting worker.

The check data management table 2710 stores information such as the following data in association with a check data number 2711: status 2712, type 2713, and action 2714.

The check data number 2711 is a number that identifies particular check data registered in the check data management table 2710.

The status 2712 is data that indicates an application status. In other words, the status 2712 indicates one of two application installation states: a successful installation state, or a failed installation state. Herein, “SUCCESS” indicates that installation was successful, while “FAILURE” indicates that installation was not successful.

The type 2713 is data that indicates a notification method, technique or technology, including the device used for notification. More specifically, “LED” indicates that the LED lamp 1400 is to be used, “VIBE” indicates that a vibrator provided in the mobile device 1000 is to be used, and “SOUND” indicates that a sound generator provided in the mobile device 1000 is to be used. While specific indicators are discussed herein, various types of indicators may be implemented with the present invention.

The action 2714 is data that indicates how the device indicated by the type 2713 is to operate.

In the case where the type 2713 is “LED”, the color and blinking pattern is indicated. The pattern is data indicating factors such as the blinking interval. In the case where the type 2713 is “VIBE”, the pattern (i.e., interval) and strength of the vibration is indicated. In the case where the type 2713 is “SOUND”, a type and strength of the melody is indicated.

For example, the check data associated with a check data number 2711 of 4 indicates that when installation has failed, a medium-strength vibration is emitted at an interval indicated by a pattern 1, while in addition, a sound 1 is played at medium strength.

The per-application management table 2720 stores information such as the following data in association with a registration number 2721: application name 2722, and check data number 2723.

The registration number 2721 is a number that identifies a particular application registered in the per-application management table 2720.

The application name 2722 is data that indicates the title of an application that can be installed by the kitting apparatus 2000.

The check data number 2723 is data that indicates the number of the check data indicated by the check data number 2711 in the check data management table 2710.

For example, when installing the mailer onto one of the mobile devices 1000, the kitting apparatus 2000 reads out the data of the check data number 2723 contained in the record (i.e., row) of the per-application management table 2720 whose application name 2722 is “MAILER”. Subsequently, the kitting apparatus 2000 reads out the status 2712, type 2713 and action 2714 data that corresponds to the same check data number as that of the data that was read out from the check data management table 2710. The kitting apparatus 2000 then transmits the retrieved data to the mobile device 1000 as the check data of the mailer.

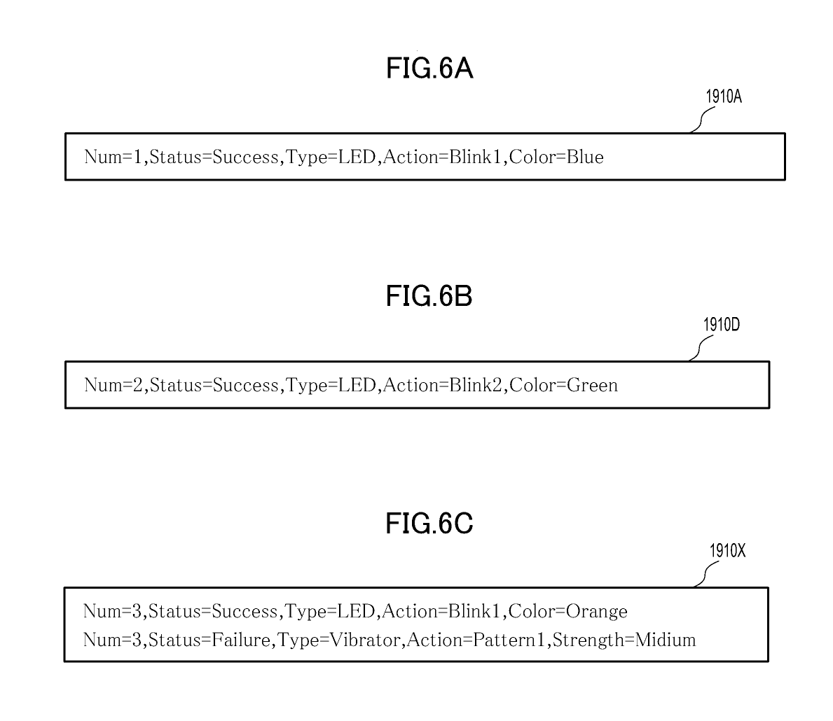

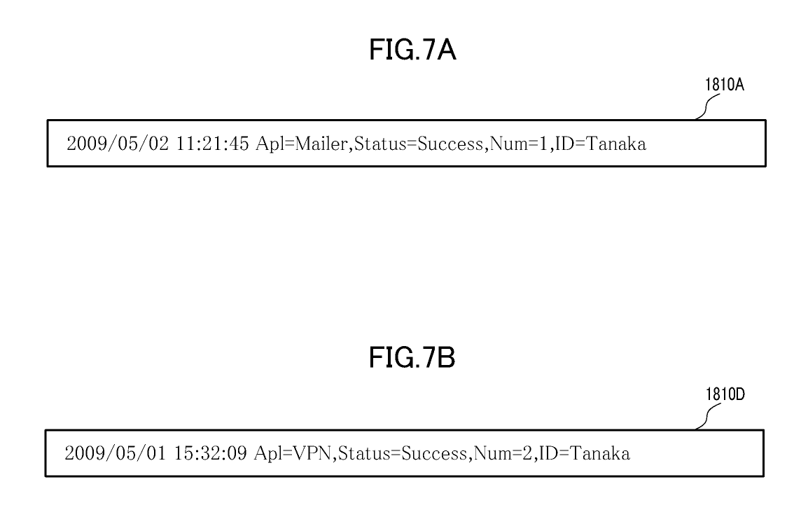

The data hereinafter described with reference to FIGS. 6A, 6B and 6C and 7A to 7B is data stored in the mobile devices 1000.

FIGS. 6A, 6B and 6C illustrate examples of a structure and content of check data 1910 stored in the check data storage unit 1900.

In FIG. 6A, the check data 1910A illustrates check data 1910 stored in the check data storage unit 1900 of the mobile device A, while in FIG. 6B, the check data 1910D illustrates check data 1910 stored in the check data storage unit 1900 of the mobile device D. Additionally, in FIG. 6C, the check data 1910X illustrates check data 1910 stored in the check data storage unit 1900 of a mobile device X.

On the basis of the check data management table 2710, the kitting apparatus 2000 specifies a check data number that corresponds to an application to be installed, and then transmits check data 1910 in the format illustrated in FIGS. 6A to 6C to the mobile devices 1000.

The check data 1910 contains “Num”, “Status”, “Type”, and “Action” elements. Herein, after “Action”, the details of the action made to be performed by the device specified by “Type” may also be specified as appropriate.

“Num” indicates the check data number. This number corresponds to the check data number 2711 in the check data management table 2710.

“Status” indicates the application status. In other words, “Status” indicates one of two application installation states: a successful installation state, or a failed installation state. The “Status” element corresponds to the status 2712 in the check data management table 2710.

“Status=Success” indicates a successful installation state, while “Status=Failure” indicates a failed installation state.

“Type” indicates the device used for notification, and corresponds to the type 2713 in the check data management table 2710.

“Action” indicates how the device indicated by “Type” is to operate, and corresponds to the action 2714 in the check data management table 2710.

By way of example, the check data 1910A illustrates check data 1910 corresponding to the mailer installed onto the mobile device A.

The check data of the mailer is the record in the check data management table 2710 (FIG. 5) whose check data number 2711 is “1”, and thus the corresponding entry “Num=1” is included in the check data 1910A (FIG. 6A). Similarly, the check data 1910A includes the entry “Status=Success”, which corresponds to the status 2712 “SUCCESS” in the check data management table 2710, the entry “Type=LED”, which corresponds to the type 2713 “LED” in the check data management table 2710, and the entry “Action=Blink1, Color=Blue”, which corresponds to the action 2714 “BLINK: PATTERN 1, COLOR: BLUE” in the check data management table 2710.

Meanwhile, the check data 1910D in FIG. 6B illustrates the check data 1910 of the VPN software installed onto the mobile device D. The check data of the VPN software is the record in the check data management table 2710 (FIG. 5) whose check data number 2711 is “2”, and thus the check data 1910D includes “Num=2”. In addition, since the status 2712 in the check data management table 2710 is “SUCCESS”, the check data 1910D includes the entry “Status=Success”. Since the type 2713 in the check data management table 2710 is “LED”, the check data 1910D includes the entry “Type=LED”. Since the action 2714 in the check data management table 2710 is “BLINK: PATTERN 2, COLOR: GREEN”, the check data 1910D includes the entry “Action=Blink2, Color=Green”.

Meanwhile, the check data 1910X illustrated in FIG. 6C illustrates the check data 1910 of the record whose check data number 2711 is “3” (FIG. 5).

The first line of the check data 1910X includes the entry “Num=3”, which corresponds to the check data number 2711 “3”. In addition, the check data 1910X includes the entry “Status=Success”, which corresponds to “SUCCESS” in the first line of the data for the status 2712 in the check data management table 2710 (FIG. 4), the entry “Type=LED”, which corresponds to “LED” in the first line of the type 2713 in the check data management table 2710, and the entry “Action=Blink1, Color=Orange”, which corresponds to “BLINK: PATTERN 1, COLOR: ORANGE” in the first line of the action 2714 in the check data management table 2710.

Additionally, the second line of the check data 1910X also includes the entry “Num=3”, which corresponds to the check data number 2711 “3”. However, since the record in the second line of the status 2712 in the check data management table 2710 is “FAILURE”, the second line of the check data 1910X includes the entry “Status=Failure”. The second line of the check data 1910X also includes the entry “Type=Vibrator”, which corresponds to “VIBE” in the second line of the data for the type 2713 in the check data management table 2710, and the entry “Action=Pattern1, Strength=Medium”, which corresponds to “VIBE: PATTERN1, STRENGTH: MED” in the second line of the data for the action 2714 in the check data management table 2710.

FIGS. 7A and 7B illustrate examples of a structure and content of an install log stored in the install log storage unit 1800.

In FIG. 7A, the install log 1810A illustrates an install log 1810 stored in the install log storage unit 1800 of the mobile device A, while in FIG. 7B, the install log 1810D illustrates an install log 1810 stored in the install log storage unit 1800 of the mobile device D.

The install log 1810 contains respective data for the creation date, as well as “Apl”, “Status”, “Num”, and “ID” elements.

The creation date indicates the date and time when the install log 1810 was created.

The “Apl” element indicates the installed application.

The “Status” element indicates one of two application installation states: a successful installation state, or a failed installation state. “Status=Success” indicates a successful installation state, while “Status=Failure” indicates a failed installation state.

The “Num” element indicates the check data number.

The “ID” element indicates the identifier (ID) of the kitting worker.

By way of example, the install log 1810A illustrates the install log 1810 of the mailer installed onto the mobile device A. The check data of the mailer is the record in the check data management table 2710 whose check data number 2711 is “1”.

Consequently, the install log 1810A contains the entry “2009/05/02 11:21:45”, which indicates that the install log 1810A was generated at 11:21:45 on May 2, 2009, the entry “Apl=Mailer”, which indicates that the mailer was installed, the entry “Status=Success”, which indicates that the installation was successful, the entry “Num=1”, which indicates that the check data number is “1”, and the entry “ID=Tanaka”, which indicates that the worker is “Tanaka”.

Similarly, the install log 1810D contains the entry “2009/05/01 15:32:09”, which indicates that the install log 1810D was generated at 15:21:09 on May 1, 2009, the entry “Apl=VPN”, which indicates that the VPN software was installed, the entry “Status=Success”, which indicates that the installation was successful, the entry “Num=2”, which indicates that the check data number is “2”, and the entry “ID=Tanaka”, which indicates that the worker is “Tanaka”.

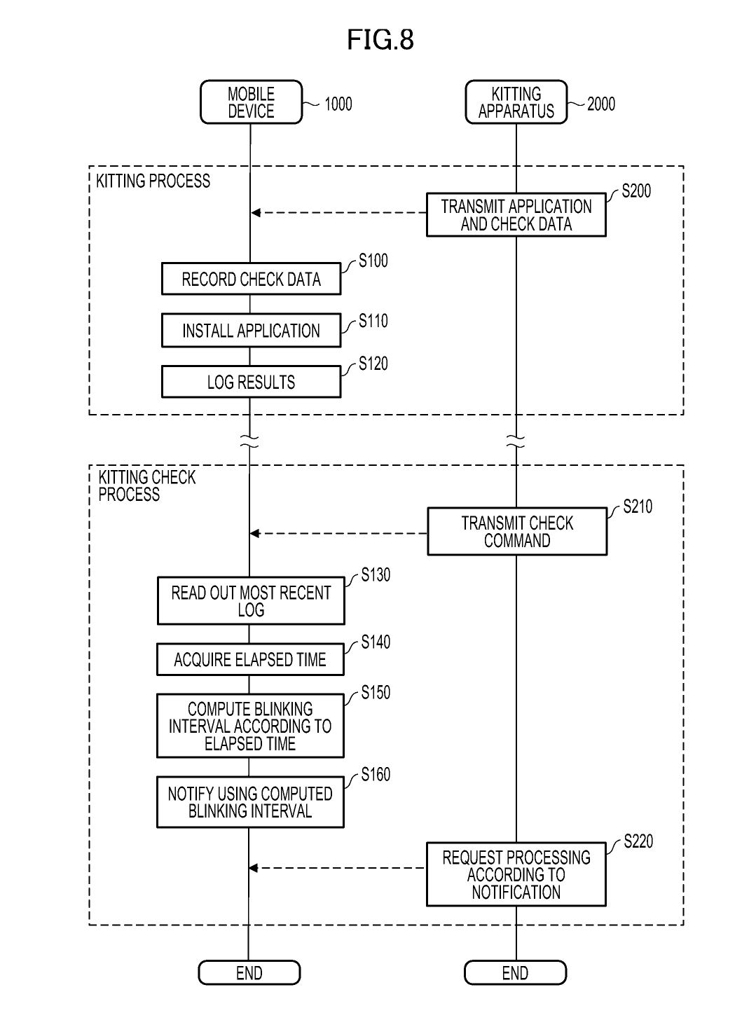

Hereinafter, the operation of the status notification system 100 of an embodiment will be described using FIG. 8.

FIG. 8 is a flowchart illustrating a kitting process and a kitting check process of the status notification system 100.

Hereinafter described are a kitting process, whereby a kitting worker uses the kitting apparatus 2000 to install applications onto one of the mobile devices 1000, and a kitting check process, whereby the installation status is checked. The kitting process is the process illustrated in operations S100 to S120 and operation S200 of FIG. 8. The kitting check process is the process illustrated in operations S130 to S160, operation S210, and operation S220.

The kitting worker connects the kitting apparatus 2000 and one of the mobile devices 1000 together by wireless LAN, and where appropriate, performs operations on the mobile device 1000. For example, the kitting worker may perform operations to set the mobile device 1000 to a mode enabling the installation of a new application.

Subsequently, the kitting worker operates the kitting apparatus 2000 to issue installation instructions specifying the application name. At this point, the kitting worker also inputs his or her own ID.

Upon detecting the operations performed by the kitting worker, the user interface 2300 of the kitting apparatus 2000 reports the detected operations to the controller 2100.

Having received the report, the controller 2100 determines that the operations are instructions for installing an application, and issues installation instructions to the kitting processor 2400. At this point, the controller 2100 passes along the application name specified by the kitting worker, as well as the kitting worker's ID.

Having received the instructions, the kitting processor 2400 first reads out from the application storage unit 2600 the application installer for the application name passed along by the controller 2100. The kitting processor 2400 then transmits the retrieved installer and the kitting worker's ID to the mobile device 1000 via the communication unit 2200.

Subsequently, in response to a request from the installer, the kitting processor 2400 reads out and transmits the application check data from the per-application check data storage unit 2700. For example, in the case where the application name specified by the user is “Mailer”, the kitting processor 2400 specifies the record with the application name 2722 “MAILER” in the per-application management table 2720 that is stored in the per-application check data storage unit 2700. The check data number 2723 contained in the specified record is read out. Next, the kitting processor 2400 specifies the record in the check data management table 2710 whose check data number 2711 is the same as the number that was read out. The kitting processor 2400 then reads out the status 2712, type 2713, and action 2714 data contained in the specified record, creates check data 1910 (see FIGS. 6A to 6C), and transmits the created check data 1910 to the mobile device 1000.

In addition, in response to a request from the installer, the kitting processor 2400 reads out and transmits information such as the application's executable file and data used by the application from the application storage unit 2600 (operation S200).

Meanwhile, in the mobile device 1000, the controller 1100 receives the installer and the kitting worker's ID via the communication unit 1200, and passes along the received installer and kitting worker's ID to the setup processor 1300.

The setup processor 1300 loads the installer into working memory, and launches the installer.

The launched installer requests and receives the application's check data 1910, and passes along the received check data 1910 to the setup processor 1300. The setup processor 1300 causes the check data 1910 received from the launcher to be stored in the check data storage unit 1900 (operation S100).

Subsequently, the installer executes the installation process. In other words, the installer requests and receives information such as the application's executable file and data used by the application from the kitting apparatus 2000, causes the received information to be stored in the application storage unit 1700, and conducts processing such as configuring relevant settings (operation S110). Subsequently, the installer reports the application installation result to the setup processor 1300. In other words, the installer reports whether the installation succeeded or failed.

Having received the report, the setup processor 1300 generates an install log 1810 according to the received installation result.

More specifically, the setup processor 1300 acquires the date and time from a timer built into the mobile device 1000, while also acquiring the application name from the installer. The setup processor 1300 then generates an install log 1810 from the application name, the installation result, the check data number contained in the check data 1910, and the kitting worker's ID that was passed along by the controller 1100.

Having generated the install log 1810, the setup processor 1300 causes the generated install log to be stored in the install log storage unit 1800 (operation S120).

A kitting check process will now be described. The kitting worker operates the kitting apparatus 2000 to transmit a check command.

Upon detecting the operations by the kitting worker, the user interface 2300 of the kitting apparatus 2000 reports the detected operations to the controller 2100.

Having received the report, the controller 2100 determines that the operations are instructions for transmitting a check command, and instructs the check request unit 2500 to transmit a check command.

Having received the instructions, the check request unit 2500 broadcasts the check command via the communication unit 2200 (operation S210). This transmission is conducted by means of wireless LAN.

In one of the mobile devices 1000, the controller 1100 receives the check command via the controller 2100, and requests the notification processor 1500 to conduct a notification process.

Having received the request, the notification processor 1500 first refers to the check data 1910 stored in the check data storage unit 1900 (see FIGS. 6A, 6B and 6C), and computes the default value for the blinking interval according to the “Action” element. More specifically, the default value for the blinking interval is computed to be 500 ms if “Action=Blink1”, and 250 ms if “Action=Blink2”. The default value for the blinking interval herein is taken to be determined in advance by the blinking pattern.

Having computed the default value for the blinking interval, the notification processor 1500 passes along the computed default value to the blinking interval determining unit 1600 and requests the determination of the blinking interval.

Having received the request, the blinking interval determining unit 1600 reads out the most recently generated install log from among the install logs stored in the install log storage unit 1800 (operation S130).

For example, if the creation date “2009/05/02 11:21:45” of the install log 1810A in FIG. 7A is the most recent among the install logs stored in the install log storage unit 1800, then that install log 1810A is read out.

Subsequently, the blinking interval determining unit 1600 acquires the current date and time from a timer built into the mobile device 1000. The blinking interval determining unit 1600 then computes, in units of hours, the elapsed time between the acquired date and time, and the date and time specified by the creation date data included in the install log (operation S140).

The blinking interval determining unit 1600 converts the elapsed time thus computed into days to compute the number of elapsed days. More specifically, the blinking interval determining unit 1600 computes the number of elapsed days by taking the product of the elapsed time divided by 24 hours.

The blinking interval extension time per day, such as 100 ms, is then multiplied by the computed number of elapsed days. The resulting value is added to the default value that was passed along from the notification processor 1500 to compute a new blinking interval (operation S250).

Having computed the new blinking interval, the blinking interval determining unit 1600 passes along the new blinking interval thus computed to the notification processor 1500.

Having received the new blinking interval, the notification processor 1500 checks whether or not the “Status” element in the retrieved install log 1810 is identical to the “Status” element in the retrieved check data 1910. If the “Status” elements are identical, then the notification processor 1500 uses the check data 1910 retrieved from the check data storage unit 1900 as a basis for controlling the blinking interval so as to become the new blinking interval, and causes the LED lamp 1400 to blink a notification.

For example, in the case where the “Status” element in the install log 1810A (see FIG. 7A) is “Status=Success”, and the “Status” element in the check data 1910A (see FIG. 6A) is “Status=Success”, the LED lamp 1400 is made to blink blue at the new blinking interval, in accordance with the check data 1910A. Herein, if the “Status” element of the install log 1810 is “Status=Failure”, and if there exists a line in the check data 1910 whose “Status” element is “Status=Failure” (see the check data 1910X in FIG. 6C), then the mobile device 1000 is made to vibrate at medium strength in accordance with the check data 1910.

If there does not exist a record in the retrieved check data 1910 with a “Status” element identical to the “Status” element in the retrieved install log 1810, then no notification is conducted.

Having seen notifications from respective mobile devices, the kitting worker performs subsequent work according to the notifications (operation S220). For example, if there is a notification indicating that installation failed, then the kitting worker performs reinstallation and similar work.

Mobile devices in the status notification system configured as above are thus able to inform the kitting worker of their corresponding various kitting statuses using an outward appearance of the devices. According to an embodiment, a notification technology is utilized to display an indicator matching a status of a device in response to a request from an external device different from the device.

In the above-described embodiment, notifications are conducted according to check data 1910 associated with applications. Another embodiment is basically similar to the above-described embodiment, in that notifications are also conducted according to the check data 1910 associated with applications. However, depending on the applications being installed, different notification patterns may resemble each other. In some cases, this can make it difficult to check the kitting status, such as the type of application installed and the time of installation.

For example, in the case where two different applications are installed onto respective mobile devices 1000, it is possible for the notification patterns indicated in the check data 1910 associated with these applications to resemble each other. For example, the lamp colors may be the same, and the blinking patterns may resemble each other.

In this case, even if the mobile devices 1000 are made to issue notifications by blinking their LED lamps, the lamp colors will be the same, and the difference in the blinking patterns will be minimal. Consequently, it will be difficult for the kitting worker to determine which applications are installed from the blinking patterns of the LED lamps in the mobile devices 1000.

As another example, in the case where the same application is installed onto a plurality of mobile devices 1000 on respectively different days, it is possible for there to be little difference among the blinking intervals, such as when the respective installation days for the mobile devices 1000 are close in time.

In this case, even if the mobile devices 1000 are made to issue notifications by blinking their LED lamps, the lamp colors will be the same since the application is the same, and the difference in the blinking patterns will be minimal. Consequently, it will be difficult for the kitting worker to determine which mobile devices 1000 were first installed with the application from the blinking patterns of the LED lamps in the mobile devices 1000.

Consequently, an embodiment makes it easier for the kitting worker to check the mobile devices 1000 by dynamically modifying the notification patterns. In this case, the kitting worker is also notified of how the notification patterns have been modified.

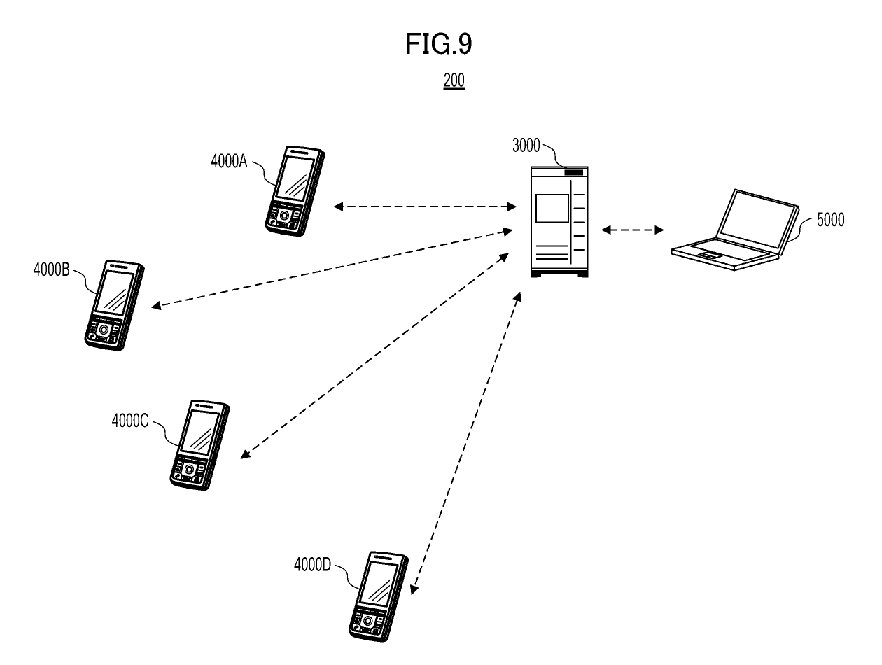

FIG. 9 illustrates an exemplary configuration of the status notification system 200 of an embodiment.

The status notification system 200 includes mobile devices 4000A, 4000B, 4000C and 4000D (4000A to 4000D unless otherwise indicated) to be kitted out, as well as a kitting apparatus 5000 and a managing server 3000.

The mobile devices 4000A to 4000D, the managing server 3000, and the kitting apparatus 5000 communicate wirelessly via a protocol such as a wireless local area network (LAN) or Bluetooth.

Herein, in an embodiment, the kitting apparatus 5000 kits out the mobile devices 4000A to 4000D via wireless LAN. In addition, the managing server 3000 communicates with the mobile devices 4000A to 4000D and the kitting apparatus 5000 by means of wireless LAN.

In an embodiment, the managing server 3000 determines the differences among notification patterns, and modifies the notification patterns with respect to the mobile devices 4000.

Herein, the mobile devices 4000A to 4000D are collectively referred to as the mobile devices 4000, with the mobile device 4000A being hereinafter referred to as the mobile device A, the mobile device 4000B as the mobile device B, the mobile device 4000C as the mobile device C, and the mobile device 4000D as the mobile device D.

The mobile devices 4000 basically include functions nearly identical to those of the mobile devices 1000 described in an embodiment. Likewise, the kitting apparatus 5000 basically includes functions nearly identical to those of the kitting apparatus 2000 described in the above-described embodiment. The differences are described in the following section.

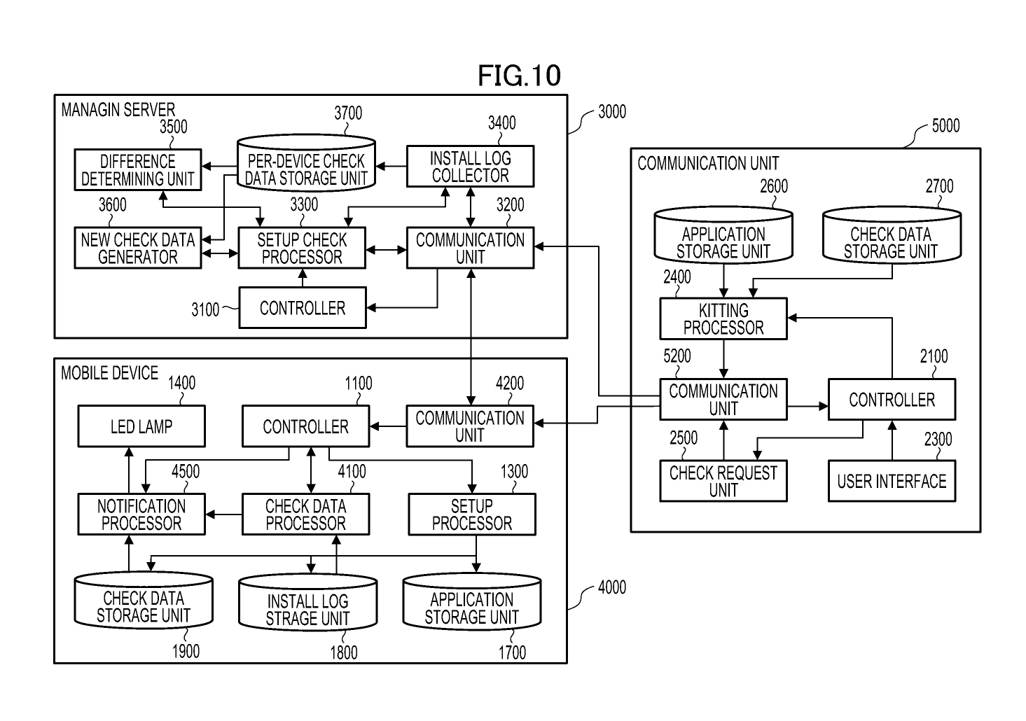

FIG. 10 is a block diagram illustrating an exemplary functional configuration of the managing server 3000, one of the mobile devices 4000, and the kitting apparatus 5000.

The managing server 3000 includes a controller 3100, a communication unit 3200, a setup check processor 3300, an install log collector 3400, a difference determining unit 3500, a new check data generator 3600, and a per-device check data storage unit 3700.

The controller 3100 realizes the functions that are basically included in the managing server 3000, such as the memory management functions of a server device. In addition, the controller 3100 also controls the other function units described above.

The communication unit 3200 wirelessly communicates with the kitting apparatus 5000 and the mobile devices 4000.

The setup check processor 3300 conducts a process for checking the kitting status when a check command is received from the kitting apparatus 5000. For example, the setup check processor 3300 may conduct a process to transmit a check command to the mobile devices 4000.

The install log collector 3400 collects install logs 1810 stored in each mobile device 4000. In an embodiment, install logs are collected, but any information may be used as long as the information enables determination of the notification patterns used when the mobile devices 4000 provisionally issue notifications. More specifically, information enabling the determination of notification patterns includes check data 1910 and the blinking interval. Consequently, in an embodiment, install logs 1810 containing the application name and the log creation date are collected.

On the basis of check data, the difference determining unit 3500 determines differences among the notification patterns when notifications are provisionally issued. In an embodiment, the difference determining unit 3500 determines whether or not there exist several elements in the check data with the same content.

In addition, on the basis of the differences thus determined, the difference determining unit 3500 determines whether or not check data should be modified, and also determines which check data 1910 to modify.

The new check data generator 3600 generates new check data.

The per-device check data storage unit 3700 includes functions for storing the install logs for each mobile device that were collected by the install log collector 3400. Furthermore, the per-device check data storage unit 3700 stores the per-application management table 2720 (see FIG. 5) and the check data management table 2710 (see FIG. 4).

Each mobile device 4000 includes a controller 1100, a communication unit 4200, a setup processor 1300, an LED lamp 1400, a notification processor 4500, an application storage unit 1700, an install log storage unit 1800, a check data storage unit 1900, and a check data processor 4100.

The controller 1100, the setup processor 1300, the LED lamp 1400, the notification processor 1500, the application storage unit 1700, the install log storage unit 1800, and the check data storage unit 1900 include functions similar to those of the setup processor 1300, the LED lamp 1400, the application storage unit 1700, the install log storage unit 1800, and the check data storage unit 1900 of one of the mobile devices 1000 described in the above-described embodiment (see FIG. 3).

The communication unit 4200 communicates with the kitting apparatus 5000 and the managing server 3000.

The check data processor 4100 includes functions for reading out an install log 1810 stored in the install log storage unit 1800, and transmitting the retrieved the install log 1810 to the managing server 3000. In addition, the check data processor 4100 receives new check data 1910 from the managing server 3000, and informs the notification processor 4500.

The notification processor 4500 conducts a process for checking the kitting status. More specifically, the notification processor 4500 conducts a notification process on the basis of either check data 1910 stored in the check data storage unit 1900, or new check data 1910 passed along from the check data processor 4100.

Meanwhile, the kitting apparatus 5000 includes a controller 2100, a communication unit 5200, a user interface 2300, a kitting processor 2400, a check request unit 2500, an application storage unit 2600, and a per-application check data storage unit 2700.

The controller 2100, the user interface 2300, the kitting processor 2400, the check request unit 2500, the application storage unit 2600, and the per-application check data storage unit 2700 include functions similar to those of the controller 2100, the communication unit 2200, the user interface 2300, the kitting processor 2400, the check request unit 2500, the application storage unit 2600, and the per-application check data storage unit 2700 of the kitting apparatus 2000 described in the above-described embodiment (see FIG. 3).

The communication unit 5200 communicates with the managing server 3000 and the mobile devices 4000.

The various functions described above are realized as a result of the respective CPUs included in the managing server 3000, the mobile devices 4000, and the kitting apparatus 2000 executing programs stored in the respective memories or similar components of the managing server 3000, the mobile devices 4000, and the kitting apparatus 2000.

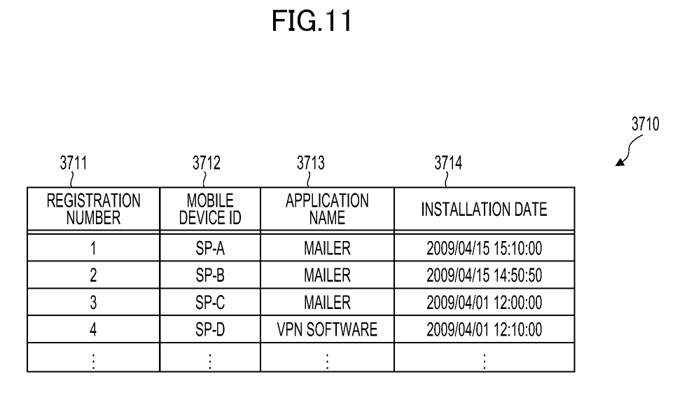

Data used by the status notification system 200 will now be described using FIG. 11. The data described with reference to FIGS. 4, 5, 6A, 6B, 6C, 7A and 7B in the above-described embodiment may also used by the status notification system 200 of another embodiment.

FIG. 11 illustrates an example of a structure and content of a per-device management table 3710.

The per-device management table 3710 is stored in the per-device check data storage unit 3700 of the managing server 3000. The install log collector 3400 causes such data to be stored each time the managing server 3000 receives a check command from the kitting apparatus 5000.

The per-device management table 3710 stores information including the following data in association with a registration number 3711: mobile device ID 3712, application name 3713, and installation date 3714.

The registration number 3711 indicates the number of a record registered in the per-device management table 3710.

The mobile device ID 3712 indicates the identifier (ID) of a mobile device 4000 managed by the managing server 3000. More specifically, the mobile device ID 3712 indicates the ID of a mobile device 4000 whose install log has been collected by the install log collector 3400.

The application name 3713 indicates the application name of the most recently installed application on the mobile device 4000 indicated by the mobile device ID 3712.

The installation date 3714 indicates the date and time of the installation of the application indicated by the application name 3713 onto the mobile device 4000 indicated by the mobile device ID 3712.

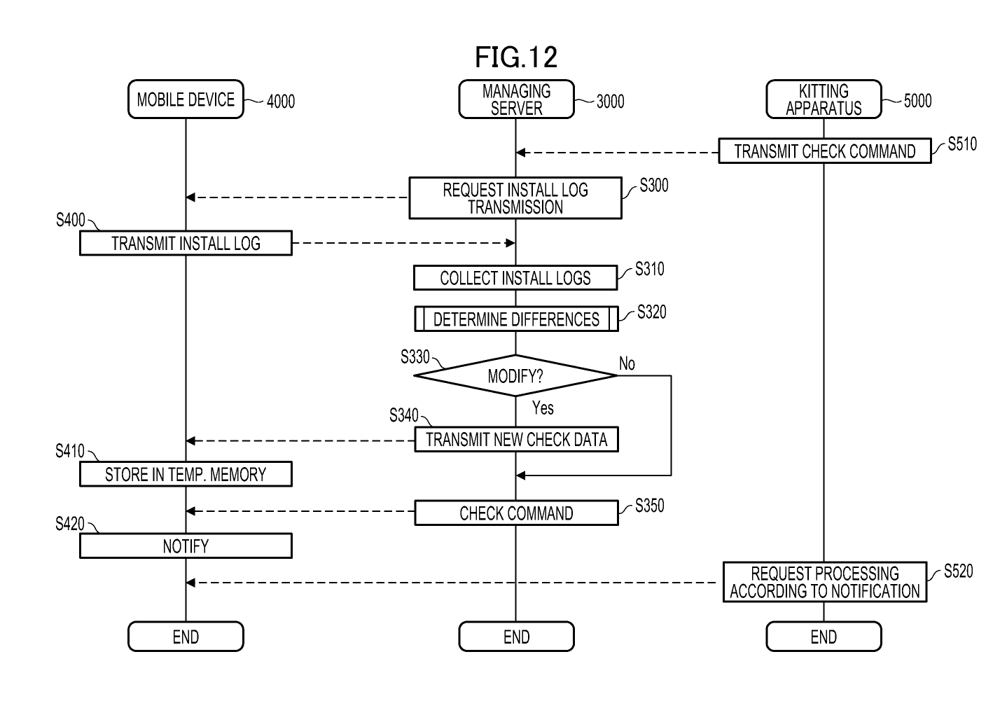

Hereinafter, operation of the status notification system 200 of an embodiment will be described using FIG. 12.

FIG. 12 is a flowchart illustrating a kitting check process of the status notification system 200.

In an embodiment, a kitting check process is also conducted after conducting a kitting process similar to the kitting process of the above-described embodiment.

Hereinafter, a kitting check process of an embodiment will be described, primarily in terms of its differences with respect to the kitting check process of the above-described embodiment.

The kitting worker performs operations with respect to the kitting apparatus 5000, and issues instructions to transmit a check command.

Upon detecting the operations performed by the kitting worker, the user interface 2300 of the kitting apparatus 5000 reports the detected operations to the controller 2100.

Having received the report, the controller 2100 determines that the operations are instructions for transmitting a check command, and instructs the check request unit 2500 to transmit a check command.

Having received the instructions, the check request unit 2500 transmits a check command to the managing server 3000 via the communication unit 5200 (operation S510).

In the managing server 3000, the controller 3100 receives the check command via the communication unit 3200, and then requests the communication unit 3200 to conduct a process for checking the kitting status of the mobile devices 4000.

Having received the request, the communication unit 3200 requests the install log collector 3400 to collect the check data 1910 respectively stored in each mobile device 4000.

Having received the request, the install log collector 3400 broadcasts to the mobile devices 4000 a log request command requesting transmission of stored install logs (operation S300).

In each of the mobile devices 4000, the controller 1100 receives the log request command via the communication unit 4200, and then requests the check data processor 4100 to acquire the most recent install log.

Having received the request, the check data processor 4100 reads out the most recent install log 1810 stored in the install log storage unit 1800, and passes along the retrieved install log 1810 to the controller 1100.

Having received the install log 1810 passed along from the check data processor 4100, the controller 1100 transmits the received install log 1810 to the managing server 3000 (operation S400).

In the managing server 3000, the install log collector 3400 receives the install log 1810 via the communication unit 3200, and then registers the received install log 1810, together with the ID of the mobile device 4000 that transmitted the data, in the per-device management table 3710.

More specifically, the title of the application specified by “APL” in the install log 1810 is set as the application name 3713, the creation date in the install log 1810 is set as the installation date 3714, and the ID of the mobile device 4000 is set as the mobile device ID 3712.

Having received an install log 1810 from each of the mobile devices 4000, the install log collector 3400 reports to the setup check processor 3300 that install logs 1810 have been collected (operation S310).

Having received the report indicating that install logs 1810 have been collected, the setup check processor 3300 subsequently requests the difference determining unit 3500 to find differences in the check data, and determine whether or not the check data should be modified.

Having received the request, the difference determining unit 3500 first references the per-application management table 2720 and the check data management table 2710 (see FIG. 4) to find differences among the check data 1910 for identical applications as indicated by the application name 3713 of the per-device management table 3710 stored in the per-device check data storage unit 3700. On the basis of the differences thus found, the difference determining unit 3500 determines whether or not to modify the check data 1910, and if so, the mobile devices to be modified (operation S320).

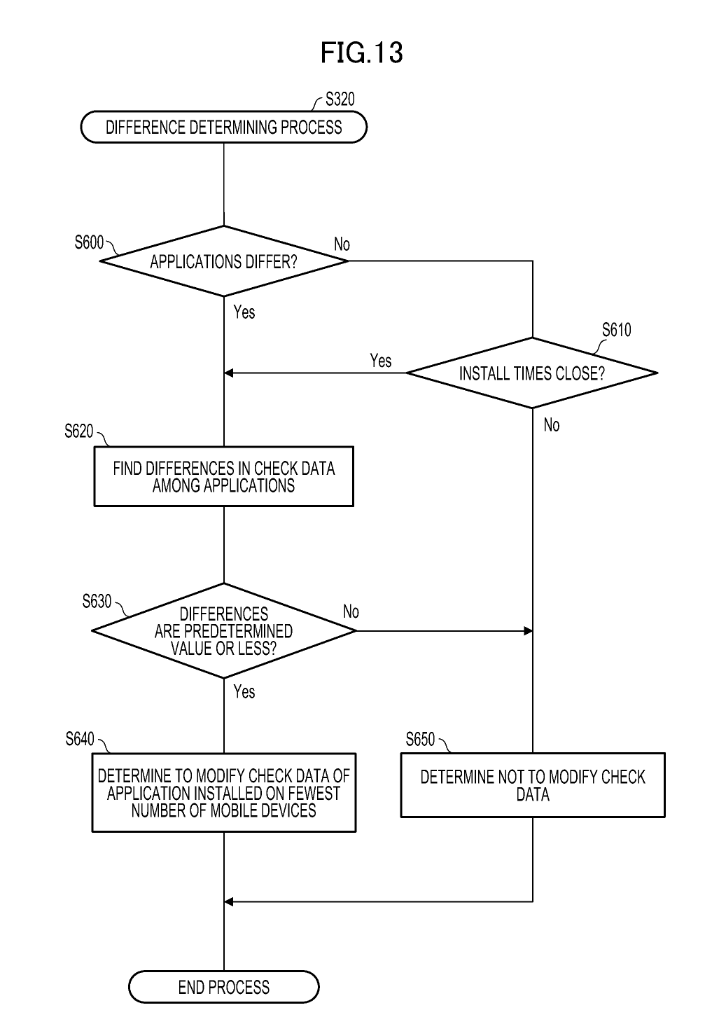

The difference determining process of the difference determining unit 3500 will be later described using FIG. 13.

Having determined whether or not to modify the check data 1910, the difference determining unit 3500 reports to the determination results to the setup check processor 3300. If the report indicates that check data 1910 is to be modified, the mobile devices 4000 to be modified are also specified in the report. More specifically, the name of an application installed onto the mobile devices 4000 is specified in the report.

The setup check processor 3300 receives the report, and if the report indicates that check data is to be modified (operation S330: Yes), then the setup check processor 3300 requests the new check data generator 3600 to generate new check data 1910. At this point, the application name is also specified.

Having received the request, the new check data generator 3600 reads out the check data of the application indicated by the application name included in the report, and generates new check data 1910 by modifying a portion of the elements constituting the retrieved check data.

For example, in the case the application is the mailer, the check data is expressed by the record in the check data management table 2710 whose check data number 2711 is “1”. Consequently, the mailer check data includes the following three elements: the type 2713 is “LED”, and the action 2714 is “BLINK: PATTERN 1” and “COLOR: BLUE”. By modifying some or all of these three elements, new check data is generated.

The question of how to modify the content of the check data to generate new check data is determined by referring to the check data of other applications. For example, the content may be modified so as to not overlap with the check data of applications other than the mailer that are registered in the application name 3713 column of the per-device management table 3710. Since the notification pattern of the VPN software causes the LED to blink green, the mailer may be made to blink a color other than green, or the blinking pattern may be changed, for example. Alternatively, the elements to be modified and the manner of the modification may also be determined randomly. Furthermore, the differences among the notification patterns may also be enhanced by adding elements of a new type, such as an on-screen display.

Having generated new check data 1910, the new check data generator 3600 passes along the new check data 1910 thus generated to the setup check processor 3300.

Having received the new check data 1910, the setup check processor 3300 references the per-device management table 3710, and transmits the new check data 1910 to the mobile devices 4000 whose check data 1910 is to be modified into the new check data 1910 (operation S340). More specifically, new check data 1910 is transmitted to the mobile devices 4000 indicated by the mobile device IDs 3712 in the records of the per-device management table 3710 where the application name 3713 is the same as the application name received from the difference determining unit 3500.

If the setup check processor 3300 receives a report from the difference determining unit 3500 indicating that check data is not to be modified (operation S330: No), then the setup check processor 3300 broadcasts a check command to the mobile devices 4000 (operation S350).

In each of the mobile devices 4000, the controller 1100 receives the new check data 1910 via the communication unit 4200. The controller 1100 then passes along the received new check data 1910 to the check data processor 4100 and requests processing.

Having received the request, the check data processor 4100 passes along the new check data 1910 thus received to the notification processor 4500, and requests that the new check data 1910 be stored in working memory.

Having received the request, the notification processor 4500 causes the new check data 1910 thus received to be stored in internal working memory as check data 1910. Herein, the check data 1910 stored in working memory at this point is deleted when a reset command is received from the managing server 3000.

In addition, in each of the mobile devices 4000, the controller 1100 receives a check command via the communication unit 4200, a requests the notification processor 4500 to conduct a notification process.

Having received the request, the notification processor 4500 reads out the check data 1910 from working memory in the case where check data 1910 is being stored in the internal working memory. In the case where check data 1910 is not being stored in the internal working memory, the notification processor 4500 reads out the check data 1910 stored in the check data storage unit 1900 (see FIGS. 6A to 6C).

The notification processor 4500 conducts a notification process on the basis of the following: the check data 1910 retrieved from either the working memory of the check data storage unit 1900, and the most recently generated install log being stored in the install log storage unit 1800 (operation S420). This notification process is similar to the processing in operations S130 to S160 of the kitting check process in the above-described embodiment that was described with reference to FIG. 8.

Having seen notifications from respective mobile devices, the kitting worker performs subsequent work according to the notifications (operation S520). For example, if there is a notification indicating that installation failed, then the kitting worker performs reinstallation and similar work.

The difference determining process conducted by the difference determining unit 3500 will now be described with reference to FIG. 13.

FIG. 13 is a flowchart illustrating a difference determining process.

Having received a determination request from the setup check processor 3300, the difference determining unit 3500 first references the per-device management table 3710 and the check data management table 2710 stored in the per-device check data storage unit 3700 (see FIG. 4), and find differences among the plurality of check data 1910 respectively corresponding to the plurality of applications.

More specifically, the difference determining unit 3500 references the application name 3713 in each record of the per-device management table 3710, and determines whether or not the registered application names are the same.

If all of the registered application names are the same (operation S600: No), then the difference determining unit 3500 determines if the respective installation dates are spaced apart by a predetermined period of time, such as an interval of seven or more days.

More specifically, the difference determining unit 3500 searches the installation dates 3714 in the per-device management table 3710, and determines whether or not the registered data are spaced apart by at least the predetermined period of time.

If the dates are spaced apart by at least the predetermined period of time (operation S610: No), then the difference determining unit 3500 determines that the check data is not to be modified (operation S650). If installation of the same application was performed on different days, then the blinking interval will be as long as the time between those days. Consequently, the kitting worker will be able to determine which mobile device 4000 was kitted out first from the outward appearance of the mobile devices 4000.

If the dates are not spaced apart by at least the predetermined period of time (operation S610: Yes), or if different applications are installed onto the mobile devices 4000 (operation S600: Yes), then the difference determining unit 3500 finds the differences among the check data 1910 of the respective applications (operation S620).

More specifically, the difference determining unit 3500 computes the number of differing elements among the elements in the check data 1910. For example, in the case where the application is the mailer, the check data is expressed by the record in the check data management table 2710 (see FIG. 4) whose check data number 2711 is “1”. Consequently, the mailer check data includes the following three elements: the type 2713 is “LED”, and the action 2714 is “BLINK: PATTERN 1” and “COLOR: BLUE”. In addition, in the case where another application is the VPN software, the check data is expressed by the record whose check data number 2711 is “2”. Consequently, the VPN software check data includes the following three elements: the type 2713 is “LED”, and the action 2714 is “BLINK: PATTERN 2” and “COLOR: GREEN”. The differences in the check data between the mailer and the VPN software are two out of three. Among the three elements, two elements (i.e., the blinking pattern and the color) differ. In addition, the type also differs between the check data whose type 2713 is “LED” and the check data whose type 2713 is “VIBE”. Thus, in this case, the differences are three out of three.

If the differences are a predetermined value such as one out of three or less (operation S630: Yes), or in other words, if the number of differing elements is one or zero out of three, then the difference determining unit 3500 determines to modify the check data corresponding to the application installed on the fewest number of mobile devices 4000 (operation S640).

For example, consider the case where there are three variations of check data. Check data 1 is “LED, BLINK: PATTERN 1, COLOR: BLUE”, check data 2 is “LED, BLINK: PATTERN 1, COLOR: ORANGE”, and check data 3 is “LED, BLINK: PATTERN 1, COLOR: GREEN”. In this case, there is one differing element among the respective check data, and thus the check data targeted for modification is the one among the above three variations whose corresponding application is installed on the fewest number of mobile devices.

If the differences are a predetermined value such as more than one out of three (operation S630: No), or in other words, if the number of differing elements is two or three out of three, then the difference determining unit 3500 determines that check data is not to be modified (operation S650).

In an embodiment, the managing server 3000 issues instructions for modifying the check data of some of the mobile devices 4000 in the case where it is determined that the notification patterns of the mobile devices 4000 are confusing.

In this modification, when the mobile devices 4000 transmit install logs to the managing server 3000 (see operation S400 of FIG. 12), the reports indicate that the notification pattern indicated by the check data 1910 is not available for execution.

For example, the check data 1910 may indicate a notification pattern wherein the LED is made to blink blue, but in the case where the mobile devices 4000 do not include functions for causing their LEDs to emit blue.

The managing server 3000 then issues instructions to modify the check data, while taking into account the notification patterns of the other mobile devices 4000.

For example, the color made to be emitted by the LEDs may be changed, or the mobile devices may be made to vibrate, for example.

In the foregoing embodiments, installation success or failure is taken to be the kitting status, but other condition(s) may also be used, as long as such conditions indicate the status of a mobile device. For example, a version, a type or similar information about an installed application may be used. Moreover, status conditions are not limited to being related to installation, and may also be information such as the on-board memory size, for example.

In the foregoing embodiments, when a notification is issued by causing the LED lamp to blink, the blinking interval is varied with respect to the elapsed time since installation. However, the color may also be varied with respect to the elapsed time, and other elements such as vibration may also be added. Furthermore, notifications may be issued according to the notification pattern indicated by the check data, irrespective of the elapsed time.

In an embodiment, the managing server acquires check data by causing the check data to be transmitted from each mobile device. However, the check data of applications that underwent installations may also be acquired from the kitting apparatus. In addition, such check data may also be stored in advance.

In the mobile devices 1000 and other mobile devices herein, all or part of the respective elements illustrated in FIG. 3 and elsewhere may be realized by integrated circuits on one or plural chips, by a computer program, or by some other configuration.

A method of verifying a status of a device is provided including determining a status of the device responsive to receiving a command from an external device and displaying an indicator identifying the status of the device responsive to receipt of the command. As described herein, a status of the device may be displayed or provided using a predetermined indicator associated with the status detection which may be modified including to take into consideration various status related information.

In the case where all or part of the elements are realized by a computer program, the computer program may be permanently written to a computer-readable recording medium, such as a memory card or CD-ROM, with a computer reading and executing the program from the recording medium. Alternatively, a computer may download and execute the program via a network.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. An apparatus, comprising:
a memory which stores notification information for notifying status of the apparatus in association with status information indicating a status of the apparatus;
a request acquisition unit which acquires a status notification request from an external apparatus;
a detector which detects the status of the apparatus; and
a notifier which specifies a notification associated with the status detected by the detector based on the notification information and the status information stored in the memory, and issues the notification according to the specified notification, when the status notification request is acquired by the request acquisition unit.

2. The apparatus according to claim 1, wherein the memory stores time information indicating a time related to a process executed by the apparatus, and
wherein the notifier modifies the specified notification according to a length of time from the time indicated by the time information to a time when the notification request was acquired by the request acquisition unit, and issues a notification according to the modified notification.

3. The apparatus according to claim 1, wherein the status indicates whether an installation of an application has succeeded or failed, and
wherein the status information and the notification information are stored in the memory when the installation process for the application is executed.

4. The apparatus according to claim 2, comprising:
a blinking display unit which issues notifications by blinking; and
wherein the notifier modifies the blinking interval of the blinking according to the length.

5. A notification system, comprising:
a plurality of apparatus; and
a server;
wherein each apparatus includes:
a memory which stores notification information for notifying status of the apparatus in association with status information indicating a status of the apparatus;
a request acquisition unit which acquires a status notification request from an external apparatus;
a detector which detects the status; and
a notifier which specifies a notification associated with the status detected by the detector based on the notification information and the status information stored in the memory, and issues a notification according to the specified notification, when a status notification request is acquired by the request acquisition unit, and
wherein the server includes a request transmitter which transmits the notification request to each apparatus.

6. The notification system according to claim 5, wherein the server includes:
a receiver which acquires a respective notification information from each of the plurality of apparatus, and
a modification information transmitter which transmits modification information for modifying the notification to at least one apparatus, when the notifications indicated by respective notification information are similar or identical.

7. The notification system according to claim 6, when one of the apparatus is unable to issue a notification according to the received modification information, the apparatus transmits to the server notification unavailability information, and
when the server receives notification unavailability information from the apparatus, the modification information transmitter of the server transmits another modification information to the apparatus.

8. A notification method executed by an apparatus for issuing a notification indicating a status of the apparatus, the method comprising:
acquiring, from an external apparatus, a notification request requesting notification of the status;
detecting the status of the apparatus;
specifying a notification associated with the status detected based on notification information and status information stored in a memory, when a status notification request is acquired; and
issuing a notification using the specified notification.

9. The notification method according to claim 8, wherein the apparatus stores time information indicating a time related to a process executed by the apparatus, and
wherein the apparatus modifies the specified notification according to a length of time from the time indicated by the time information to a time when the notification request was acquired, and issues a notification according to the modified notification.

10. The notification method according to claim 8, wherein the status indicates whether the installation of an application has succeeded or failed, and
wherein the status information and the notification information are stored when the installation process for the application is executed.

11. The notification method according to claim 8, wherein, according to a length, the apparatus modifies a blinking interval of a blinking display that issues the notification by blinking.

12. A method executed by a device for verifying a status of the device, comprising:
determining a status of the device responsive to receiving a command from an external device; and
displaying an indicator identifying the status of the device responsive to receipt of the command.
